(19) United States
(12) Patent Application Publication
(10) Pub. No.: US 2026/0354942 A1
(43) Pub. Date: Nov. 12, 2026

(54) IMPLANT RETAINED OVERDENTURE ATTACHMENT WITH AN OPEN RING SYSTEM

(71) Applicant: Ajman University, AJman (AE)

(72) Inventors: Vinay Sivaswamy, Ajman (AE); Sudhir Rama Varma, Ajman (AE)

(73) Assignee: Ajman University, Ajman (AE)

(21) Appl. No.: 19/201,862

(22) Filed: May 7, 2025

(51) Int. Cl. A61C 8/00

(52) U.S. Cl. CPC A61C 8/0062; A61C 8/0057

(57) ABSTRACT

The apparatus includes an overdenture attachment system. The overdenture attachment has a broad projection over a narrow stem atop an implant abutment. A gasket will provide retention around the narrow stem. An open ring housing will contain the gasket and will be embedded in the overdenture.

### BACKGROUND

Overdentures are a type of removable denture that can replace missing teeth and are supported by natural teeth, dental implants, or tooth roots. Overdentures are retained by components called “Attachments” which need to be secured in remaining tooth or in dental implants. These Attachments retain the overdenture prostheses inside the oral cavity and prevent them from getting dislodged during function. Presently, there are very few attachments available that provide an efficient low-profile solution for overdentures.

### BRIEF DESCRIPTION OF DRAWINGS

FIG. 1 is a concept illustration of an overdenture attachment;

FIG. 2 is another concept illustration of an overdenture attachment.

FIG. 3 is another concept illustration of an overdenture attachment;

FIG. 4 is another concept illustration of an overdenture attachment;

FIG. 5 is another concept illustration of an overdenture attachment;

FIG. 6 is an example perspective view of an overdenture attachment system;

FIG. 7 is another example perspective view of an overdenture attachment system;

FIG. 8 is another example perspective view of an overdenture attachment system;

FIG. 9 is an example perspective view of overdenture attachment gasket; and

FIG. 10 is an example perspective view of overdenture attachment housing;

### DETAILED DESCRIPTION OF PREFERRED EMBODIMENTS

The following detailed description refers to the accompanying drawings. The same reference numbers in different drawings may identify same or similar elements.

Systems, devices, and/or methods described herein are for implant retained overdenture attachments. In embodiments, the described implant retained overdenture attachment provides for a low-profile solution for overdentures.

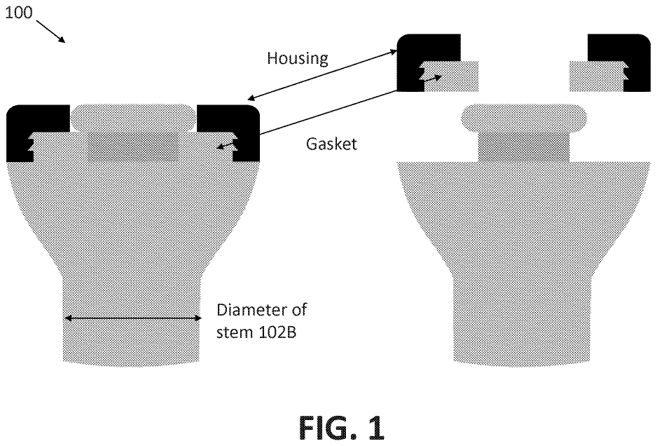

FIG. 1 shows overdenture 100. This innovation utilizes a combination of a flat projection with a narrow diameter stem on top of an implant abutment. As shown in FIG. 1, a hard rubber gasket corresponding to the diameter of the narrower stem 102B will slip over the broader projection thereby providing retention. As shown in FIG. 1, the gasket will be housed in an open ring stainless steel housing. The housing and gasket assembly will be embedded in the intaglio surface of the overdenture.

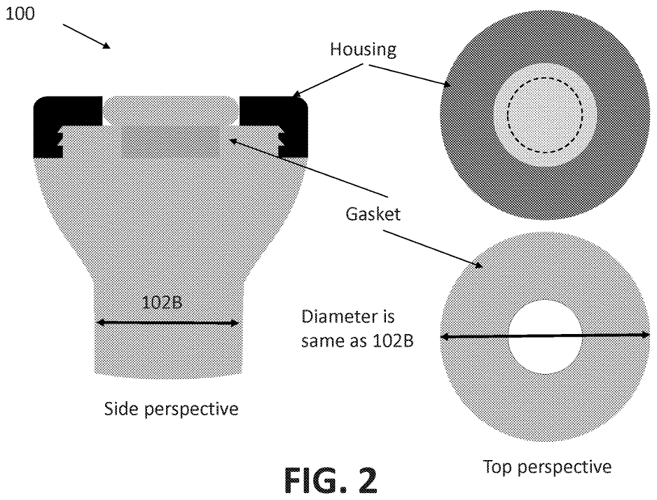

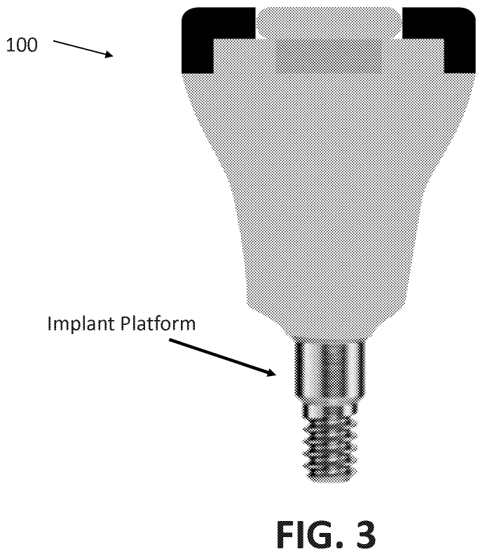

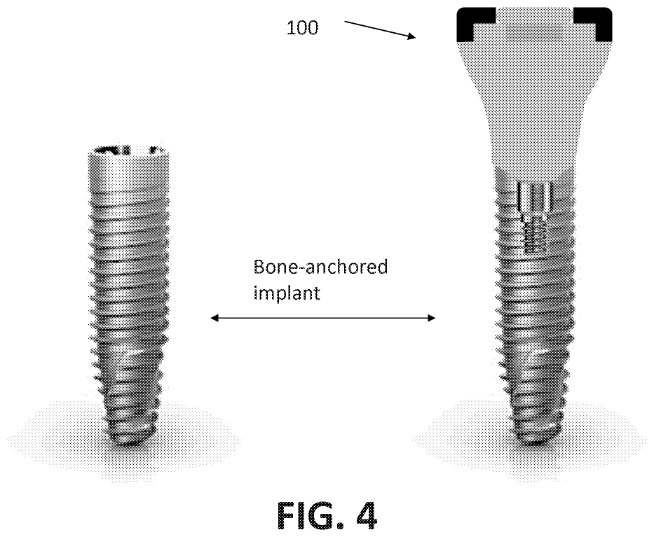

FIG. 2 further describes overdenture 100 with the side perspective view and also top perspective views of the gasket and the housing. FIG. 3 shows the entire attachment apparatus with the implant abutment 100. FIG. 4 shows overdenture apparatus 100 inserted into an implant platform. As shown in FIG. 4, overdenture apparatus 100 secured by a bone anchored implant will provide retention to the overdenture prostheses.

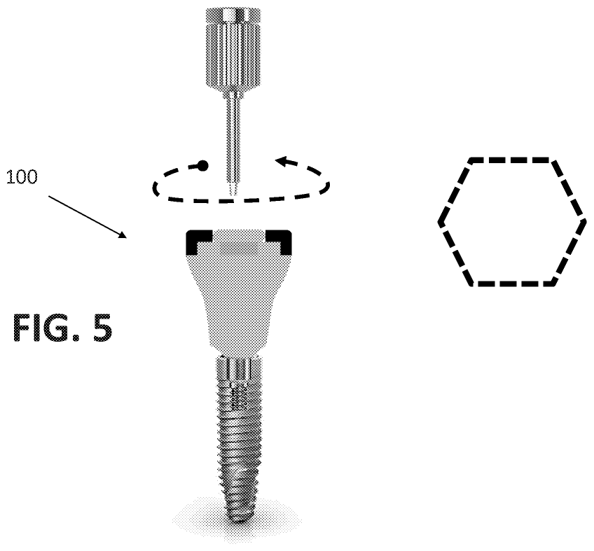

FIG. 5 shows how a key can be used to tighten or loosen the top head of overdenture 100. In embodiments, the key may be inserted into the slot which can be used to turn the top of overdenture 100 and, as such, to remove overdenture 100 from the mouth area.

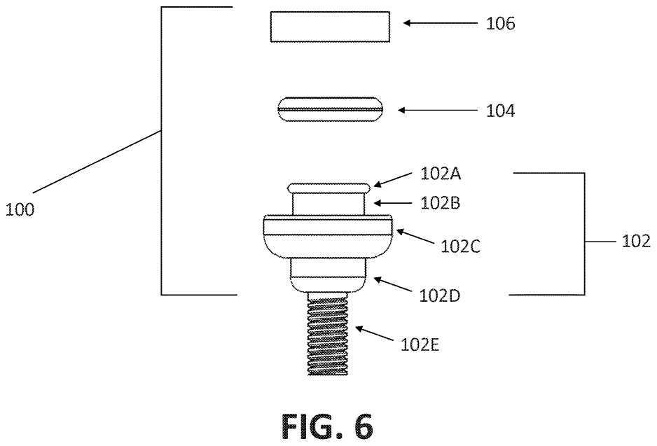

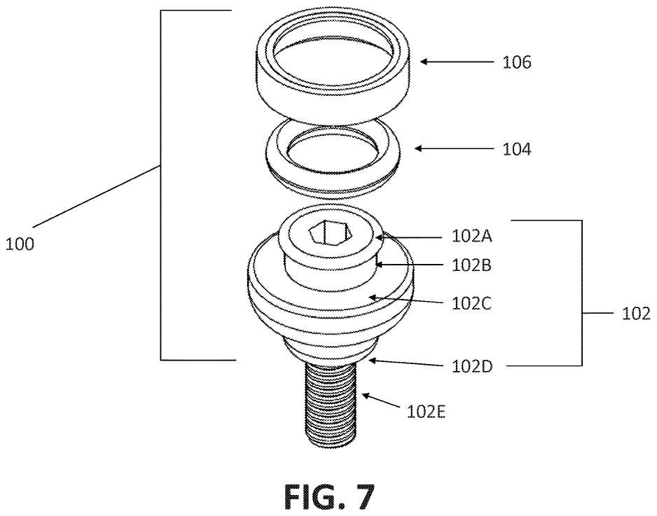

FIG. 6 shows a side perspective of overdenture attachment 100. This innovation utilizes a combination of a flat rounded projection supported by a narrower diameter stem on top of an implant abutment. As shown in FIG. 7, a hard rubber gasket corresponding to the diameter of the narrower stem will slip over the broader projection thereby providing retention. As shown in FIG. 7, the gasket will be housed in an open ring stainless steel housing. The housing and gasket assembly will be embedded in the tissue surface of the overdenture. The overdenture attachment abutment will be secured directly to the implant platform as seen in FIG. 4. In embodiments, screw portion 102E is the primary mode of anchorage into the implant platform.

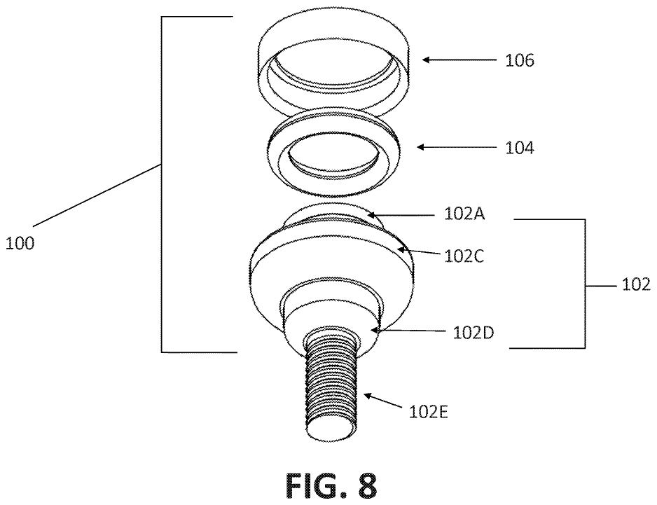

FIG. 6 describes overdenture attachment 100 with a side perspective view of the overdenture attachment system with gasket and housing. FIGS. 7 and 8 further describes overdenture 100 with isometric perspective views of the overdenture attachment along with the gasket and housing.

FIG. 5 shows how a key can be used to secure or dislodge the top head of overdenture 100. The key is an implant component screwdriver, commercially known as an implant hex drive and is hexagonal in shape. The screwdriver is universally used by all common implant systems and the described overdenture attachment also uses the same.

FIG. 6 shows overdenture attachment 102. As shown in FIG. 6, overdenture attachment 102 has a flat rounded projection 102A supported by a narrow diameter stem 102B positioned on top of an implant abutment 102C and 102D. In embodiments, the flat rounded projection 102A may have a diameter of 2.75 mm to 3.25 mm. In embodiments, the height of 102A may range from 1 mm to 1.75 mm. In embodiments, the stem 102B may have a diameter of 2.5 mm to 3 mm and the height may be 1.5 mm to 1.75 mm. In embodiments, the implant abutment 102C may have a diameter of 3.75 mm to 4.5 mm depending on the width of the implant used. The implant connection region 102D may have a diameter of 2.5 to 3 mm depending on the implant system. The height of 102C and 102D may range from 2.5 mm to 6 mm depending on the thickness of the gingival tissue.

FIGS. 7 and 8 show additional isometric perspectives of the overdenture attachment abutment 100.

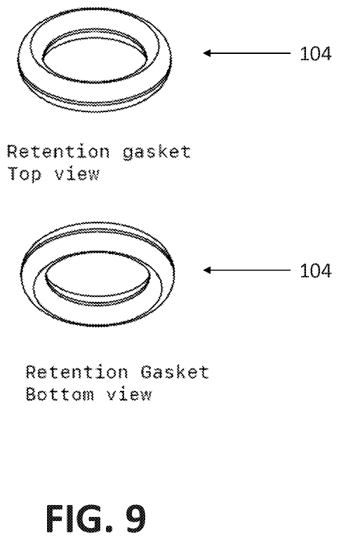

FIG. 9 shows perspective isometric top and bottom views of overdenture attachment gasket 104. In embodiments, the diameter of the inner hole of the gasket 104 may be 2.5 mm to 3 mm. In embodiments, the thickness of the gasket may be 1.5 mm to 1.75 mm. The gasket 104 may be fabricated from silicone material to impart high flexibility and elasticity. The gasket 104 may be modified to feature reversed projections on the outer sides to impart self-retentive capability.

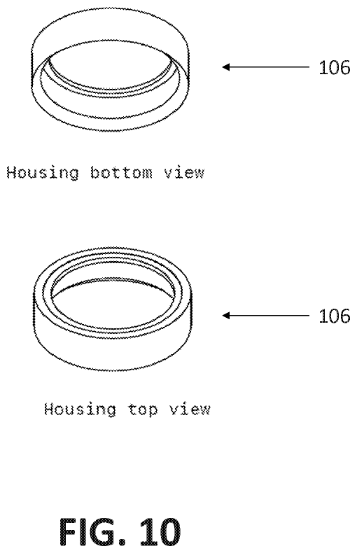

FIG. 10 shows perspective isometric top and bottom views of overdenture attachment housing 106. In embodiments, the diameter of the housing may be 3.75 mm to 4.5 mm. The housing 106 features a circular opening on the surface which has a diameter of 2 mm to 3 mm. The housing 106 may be modified to feature reversed ridges to retain the gasket 104. The housing 106 may also be modified to feature ridges on the outer sides to enable retention to the overdenture tissue surface.

In embodiments, the attachment shape 102A and 102B and the open ring housing 106 provides a low-profile solution for overdentures. The shape of the male portion (rounded projection with narrow stem) of the attachment and the shape of the female portion (open metal housing 106) will be unique to this innovation and is a differentiating feature from commercial attachment systems.

In embodiments, the described apparatus provides a low-profile attachment solution for overdentures in the lower arch. The retention system (102A, 102B, 102C) is simple and does not contain any movable parts and is estimated to reduce wear of the connecting male and female components. Since it is designed to feature a low-profile (low height of the entire attachment apparatus 102A, 102B, 102C), this attachment system can be used in cases of reduced inter-arch space. In embodiments, the overdenture is easy to adapt with no requirement to learn a new system or method, and is estimated to provide improved retention for implant retained overdentures. The improved retention is derived by the gasket engaging the undercut of the narrow stem 102B. The broader projection 102A prevents immediate vertical displacement of the gasket 104. Since the gasket 104 is fabricated from silicone, gradual vertical force will aid in displacing the overdenture away from the attachment in case of removal.

In embodiments, the attachment system 102 can be adapted for tooth supported overdenture cases by replacing the implant abutment 102C and 102D with a radicular post (tapered cylinder designed to engage a prepared root canal). This modification can be made of either castable resin for custom fabrication or with metal as a prefabricated attachment system.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
an attachment assembly fixed to an implant abutment;
a housing, wherein the housing has an open surface;
an overdenture attachment, wherein the overdenture attachment includes:
a flat rounded projection, wherein the flat rounded projection has a top flat surface and a hexagonal-shaped hole,
a stem, wherein the flat rounded projection is on top of the stem, wherein:
the stem has a smaller diameter than the flat rounded projection diameter, and
the stem has a diameter of 2.5 mm to 3 mm and the stem's height is 1.5 mm to 1.75 mm,
an implant abutment, wherein the stem is placed on top of the implant abutment, and
an implant connection region, wherein the implant connection region is mounted below the implant abutment and above a screw portion of the overdenture attachment, wherein the flat rounded projection, the narrow diameter stem, the implant abutment, the implant connection region, and the screw portion are affixed to each other and cannot be separated;
a gasket that is configured to encircle the attachment assembly, wherein:
the gasket is located within the housing,
the gasket has an inner hole diameter of 2.5 mm to 3 mm,
the gasket is placed onto a flat surface of the flat rounded projection,
the gasket has a diameter that is not greater or equal in size than a diameter of the implant abutment,
the flat rounded projection's height is 1.75 mm and the flat rounded projection has a top flat surface, wherein:
the hexagonal-shaped hole is configured to receive a key to remove the gasket and the housing from the overdenture attachment; and
a housing, wherein the housing has a diameter that is equal to the implant abutment's diameter and wherein the housing does not cover the top flat surface of the flat rounded projection.

2. The apparatus of claim 1, wherein the apparatus is fixed to the implant body directly.

3. The apparatus of claim 1 wherein the apparatus is configured to provide retention to overdentures.

4. The apparatus of claim 1, wherein the apparatus is configured to provide retention by slipping the housing-gasket assembly on the attachment.

5. (canceled)

6. (canceled)

7. The apparatus of claim 1, wherein the apparatus is configured for installation in a reduced interarch area within a person's mouth based on the flat rounded projection height.
